(19) United States
(12) Patent Application Publication
(10) Pub. No.: US 2009/0002126 A1
(43) Pub. Date: Jan. 1, 2009

(54) Information processing apparatus, information processing method, and program

(75) Inventor: Takeshi Okazaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/230,492

(22) Filed: Aug. 29, 2008

Related U.S. Application Data
(63) Continuation of application No. PCT/JP2006/306924, filed on Mar. 31, 2006.

(51) Int. Cl. G08B 29/00

(52) U.S. Cl. 340/5.53

(57) ABSTRACT

An information processing apparatus of the invention comprises: one input operation unit (button) which is operated in a specific way; and a locked/unlocked mode switching processing unit which, when the input operation unit is operated in the specific way, carries out processing to emulate a key operation corresponding to a lock request operation if the information processing apparatus is in an unlocked mode, but carries out processing to emulate a key operation corresponding to an unlock request operation if the information processing apparatus is in a locked mode, and thus the invention accomplishes the locking/unlocking of the information processing apparatus by operating the one input operation unit in the specific way.

### CROSS-REFERENCE TO RELATED APPLICATION

This application is a continuation application and is based upon PCT/JP2006/306924, filed on Mar. 31, 2006.

### FIELD

The present invention relates to an information processing apparatus, an information processing method, and a program, and more specifically to an information processing apparatus, an information processing method, and a program for locking and unlocking the information processing apparatus by a simple operation.

### BACKGROUND ART

Recent information processing apparatus are equipped with security measures to prevent unauthorized use by other than authorized users. For example, to ensure security, a password-protected screen saver is installed in advance on the information processing apparatus, and whenever a user walks away from the apparatus, the apparatus is immediately put in a locked state, thus preventing unauthorized users from using it while the authorized user is away. Usually, to lock the information processing apparatus equipped with a computer, the user presses a shortcut key comprising a predetermined combination of keys, for example, [Windows (registered trademark) key]+[L].

Further, when the user returns, authentication (password authentication, biometric authentication, or the like) to identify the authorized user must be done before the user is permitted to access the information processing apparatus. In this case, the user first presses the [CTRL]+[ALT]+[DEL] key combination to set the apparatus from the locked state to the unlocked state, and then performs authentication such as password authentication or biometric authentication.

However, simultaneously pressing multiple keys, such as [Windows (registered trademark) key]+[L] or [CTRL]+[ALT]+[DEL], is rather awkward, and in particular, simultaneously pressing three or more keys, such as [CTRL]+[ALT]+[DEL], is not possible with one hand, though it may depend on the type of the keyboard used, and thus the user operation for obtaining security is not simple.

The invention disclosed in patent document 1 provides an information processing apparatus (a system equipped with a computer) and method that can lock the system by a single button in order to simplify the user operation for obtaining security. According to the invention disclosed in patent document 1, the system comprises: hardware which detects the depression of a security button and sends that information to the BIOS accordingly; the BIOS which, in response to the notification of the security button depression, issues to a memory-resident program the same event as the event that will be issued when a key or a key combination for activating a screen saver to lock the system is depressed; and an API which, under control of an OS, requests activation of the screen saver to implement the system lock in response to the event issued from the BIOS, wherein in response to the request from the memory-resident program, the API activates the screen saver to lock the system.

Patent document 1: Japanese Unexamined Patent Publication No. 2004-5214 (refer to claims, paragraphs [0001] and [0008] to [0010] in the specification, FIG. 4, and abstract)

### DISCLOSURE OF THE INVENTION

The invention disclosed in patent document 1 requires an additional button to unlock the locked system, i.e., a total of two buttons to lock and unlock the system, and thus has a problem that the cost and the mounting space increase compared with the case of a single button.

The present invention has been devised to resolve the above problem, and an object of the invention is to provide an information processing apparatus, an information processing method, and a program that can accomplish the locking and unlocking of the system by a simple operation using a single button without increasing the cost or the mounting space.

### MEANS FOR SOLVING THE PROBLEM

An information processing apparatus according to a first mode of the invention comprises: one input operation unit which is operated in a specific way; and a locked/unlocked mode switching processing unit which, when the input operation unit is operated in the specific way, carries out processing to emulate a prescribed operation corresponding to a lock request operation if the information processing apparatus is in an unlocked mode, but carries out processing to emulate a prescribed operation corresponding to an unlock request operation if the information processing apparatus is in a locked mode.

An information processing apparatus according to a second mode of the invention comprises: one input operation unit which is operated in a specific way; and a locked/unlocked mode switching processing unit which, when the input operation unit is operated in the specific way, carries out processing to emulate a [Windows (registered trademark) key]+[L] key operation corresponding to a lock request operation if the information processing apparatus is in an unlocked mode, but carries out processing to emulate a [CTRL]+[ALT]+[DEL] key operation corresponding to an unlock request operation if the information processing apparatus is in a locked mode.

The information processing apparatus according to the first mode of the invention further comprises a storage unit which, when the input operation unit is operated in the specific way while the information processing apparatus is in the unlocked mode, stores information indicating the information processing apparatus switched to the locked mode and, when the input operation unit is operated in the specific way while the information processing apparatus is in the locked mode, stores information indicating the information processing apparatus switched to the unlocked mode.

In the information processing apparatus according to the first mode of the invention, the storage unit is provided within the mode switching processing unit, wherein when the input operation unit is operated in the specific way, the input operation unit communicates with the mode switching processing unit and checks the information stored in the storage unit to determine whether the information processing apparatus is in the locked mode or the unlocked mode, and when it is determined that the information processing apparatus is in the unlocked mode, the input operation unit sends a lock request to the mode switching processing unit which, in response, carries out the processing to emulate the prescribed operation corresponding to the lock request operation, but when it is determined that the information processing apparatus is in the locked mode, the input operation unit sends an unlock request to the mode switching processing unit which, in response, carries out the processing to emulate the prescribed operation corresponding to the unlock request operation.

In the information processing apparatus according to the first mode of the invention, the storage unit is provided within the input operation unit, wherein when the input operation unit is operated in the specific way, the input operation unit checks the information stored in the storage unit to determine whether the information processing apparatus is in the locked mode or the unlocked mode, and when it is determined that the information processing apparatus is in the unlocked mode, the input operation unit sends a lock request to the mode switching processing unit which, in response, carries out the processing to emulate the prescribed operation corresponding to the lock request operation, but when it is determined that the information processing apparatus is in the locked mode, the input operation unit sends an unlock request to the mode switching processing unit which, in response, carries out the processing to emulate the prescribed operation corresponding to the unlock request operation.

The information processing apparatus according to the first or second mode of the invention further comprises a biometric information reading unit, wherein the input operation unit is disposed near the biometric information reading unit so that when the input operation unit is operated in the specific while the information processing apparatus is in the locked mode, an authentication operation using the biometric information reading unit can be performed immediately after the processing to emulate the prescribed operation corresponding to the unlock request operation has been carried out.

An information processing method for use in the information processing apparatus according to the first mode of the invention comprises the steps of: detecting a specific operation performed on one input operation unit; and switching the information processing apparatus between locked and unlocked modes in such a manner that when the specific operation is detected, if the information processing apparatus is in the unlocked mode, processing is carried out to emulate the prescribed operation corresponding to the lock request operation; however if the information processing apparatus is in the locked mode, processing is carried out to emulate the prescribed operation corresponding to the unlock request operation.

An information processing method for use in the information processing apparatus according to the second mode of the invention comprises the steps of: detecting a specific operation performed on one input operation unit; and switching the information processing apparatus between locked and unlocked modes in such a manner that when the specific operation is detected, if the information processing apparatus is in the unlocked mode, processing is carried out to emulate the [Windows (registered trademark)]+[L] key operation corresponding to the lock request operation; however if the information processing apparatus is in the locked mode, processing is carried out to emulate the [CTRL]+[ALT]+[DEL] key operation corresponding to the unlock request operation.

In the information processing method according to the first mode of the invention, the information processing apparatus includes a storage unit which, when the specific operation is performed on the input operation unit while the information processing apparatus is in the unlocked mode, stores information indicating the information processing apparatus switched to the locked mode, and when the specific operation is performed on the input operation unit while the information processing apparatus is in the locked mode, stores information indicating the information processing apparatus switched to the unlocked mode, wherein the mode switching processing step carries out the mode switching by referring to the information stored in the storage unit.

A program for use in the information processing apparatus according to the first mode of the invention causes the information processing apparatus to perform the steps of: detecting a specific operation performed on one input operation unit; and switching the information processing apparatus between locked and unlocked modes in such a manner that when the specific operation is detected, if the information processing apparatus is in the unlocked mode, processing is carried out to emulate the prescribed operation corresponding to the lock request operation; however if the information processing apparatus is in the locked mode, processing is carried out to emulate the prescribed operation corresponding to the unlock request operation.

A program for use in the information processing apparatus according to the second mode of the invention causes the information processing apparatus to perform the steps of: detecting a specific operation performed on one input operation unit; and switching the information processing apparatus between locked and unlocked modes in such a manner that when the specific operation is detected, if the information processing apparatus is in the unlocked mode, processing is carried out to emulate the [Windows (registered trademark)]+[L] key operation corresponding to the lock request operation; however if the information processing apparatus is in the locked mode, processing is carried out to emulate the [CTRL]+[ALT]+[DEL] key operation corresponding to the unlock request operation.

In the program according to the first mode of the invention, the information processing apparatus includes a storage unit which, when the specific operation is performed on the input operation unit while the information processing apparatus is in the unlocked mode, stores information indicating the information processing apparatus switched to the locked mode, and when the specific operation is performed on the input operation unit while the information processing apparatus is in the locked mode, stores information indicating the information processing apparatus switched to the unlocked mode, wherein the mode switching processing step carries out the mode switching by referring to the information stored in the storage unit.

### EFFECT OF THE INVENTION

According to the information processing apparatus, information processing method, and program of the present invention, the locking and unlocking of the information processing apparatus can be accomplished by a simple operation by operating a single input operation unit in a specific way, for example, by depressing a single button, and without increasing the cost or the mounting space.

### BRIEF DESCRIPTION OF THE DRAWINGS

FIG. 1 is a block diagram showing the configuration of an information processing apparatus according to one embodiment of the present invention.

FIG. 2A is a diagram showing a first embodiment of the processing for switching the system between locked and unlocked states in response to the depression of an input operation unit, the diagram showing the processing for switching the system from the unlocked state to the locked state.

FIG. 2B is a diagram showing the first embodiment of the processing for switching the system between locked and unlocked states in response to the depression of the input operation unit, the diagram showing the processing for switching the system from the locked state to the unlocked state.

FIG. 3A is a diagram showing a second embodiment of the processing for switching the system between locked and unlocked states in response to the depression of the input operation unit, the diagram showing the processing for switching the system from the unlocked state to the locked state.

FIG. 3B is a diagram showing the second embodiment of the processing for switching the system between locked and unlocked states in response to the depression of the input operation unit, the diagram showing the processing for switching the system from the locked state to the unlocked state.

FIG. 4 is a diagram showing a first arrangement example of a button and a fingerprint sensor on the information processing apparatus.

FIG. 5 is a diagram showing a second arrangement example of a button and a fingerprint sensor on the information processing apparatus.

FIG. 6 is a diagram showing an example in which the button is incorporated into a fingerprint sensor externally connected to the information processing apparatus.

### DESCRIPTION OF THE REFERENCE NUMERALS

1. INFORMATION PROCESSING APPARATUS
22, 32, 106. BUTTON INTERFACE
20, 30, 110. MODE SWITCHING PROCESSING UNIT
21, 31, 112. INPUT OPERATION UNIT
220, 320. STORAGE UNIT
43, 53, 210, 310, 610. BUTTON

### BEST MODE FOR CARRYING OUT THE INVENTION

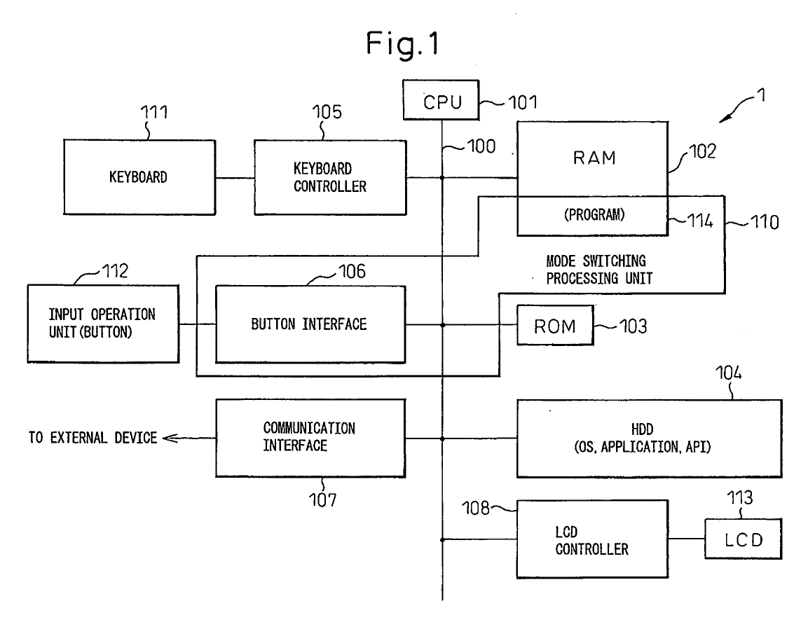

FIG. 1 is a block diagram showing the configuration of an information processing apparatus according to one embodiment of the present invention. The information processing apparatus 1 which carries out various functions shown in FIG. 1 comprises a CPU 101, a RAM 102, a ROM 103, a HDD 104, a keyboard controller 105, a button interface 106, a communication interface 107, and an LCD controller 108, which are interconnected via a bus line 100 so as to be able to communicate with each other. A keyboard 111 is connected to the keyboard controller 105, while an input operation unit 112 provided with a button that can be depressed to implement a specific operation according to the present invention is connected to the button interface 106; on the other hand, an external device is connected to the communication interface 107; and an LCD 113 is connected to the LCD controller 108. An OS, various application programs, and an API (Application Program Interface) are stored on the HDD 104, and are loaded as needed into the RAM 102 for use by the CPU 101.

The information processing apparatus 1 is a system constructed from such a computer, and includes a mode switching processing unit 110 for switching the system between locked and unlocked states. The information processing apparatus 1 will hereinafter be referred to as the system where necessary. The mode switching processing unit 110 includes the button interface 106 and incorporates a program 114 for carrying out the mode switching. When a notification indicating the depression of the button is received from the input operation unit 112 via the button interface 106, the mode switching processing unit 110 executes the program for causing the OS to lock or unlock the system via the API in accordance with the locked/unlocked state of the system at that time. In other words, when the system is in the unlocked mode, the locked/unlocked mode switching processing unit 110 carries out processing to emulate a [Windows (registered trademark) key]+[L] key operation corresponding to a lock request operation, and when the system is in the locked mode, it carries out processing to emulate a [CTRL]+[ALT]+[DEL] key operation corresponding to an unlock request operation.

### EMBODIMENT 1

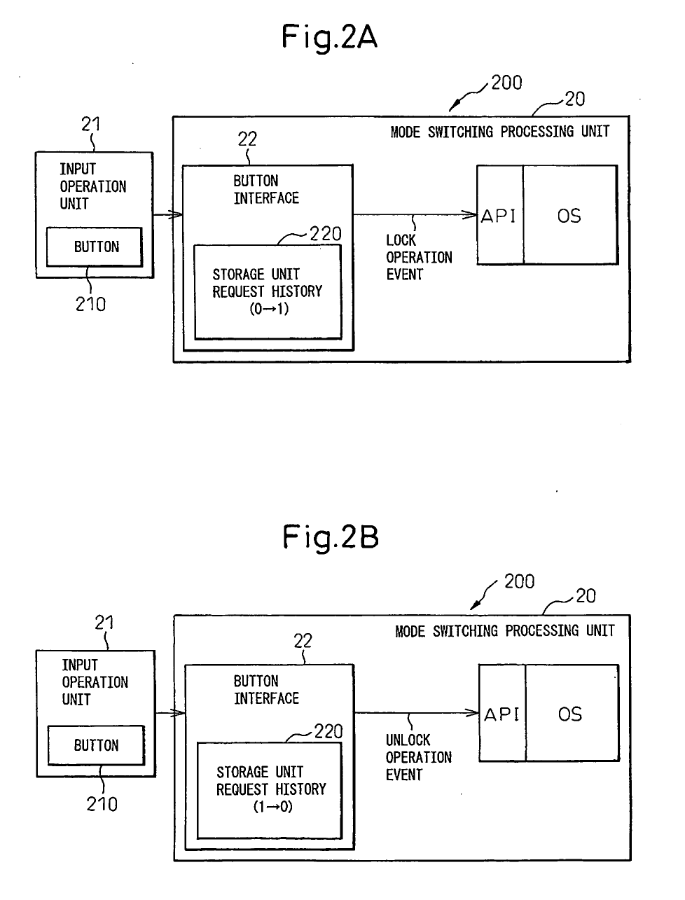

FIGS. 2A and 2B show a first embodiment of the processing for switching the system between the locked and unlocked states in response to the depression of the input operation unit: FIG. 2A is a diagram showing the processing for switching the system from the unlocked state to the locked state, and FIG. 2B is a diagram showing the processing for switching the system from the locked state to the unlocked state. As shown in FIGS. 2A and 2B, the mode switching processing unit 20 in the information processing apparatus 200 of this embodiment includes a storage unit 220 for storing the system's locked/unlocked state activated by the depression of the button 210 of the input operation unit 21 and effected by the mode switching processing unit 20.

First, the processing for switching the system from the unlocked state to the locked state will be described with reference to FIG. 2A.

Step S1: The button 210 is depressed.

Step S2: The input operation unit 21 notifies the button interface 22 of the depression of the button 210.

Step S3: The button interface 22 that received the notification from the input operation unit 21 detects the depression of the button 210, refers to the system lock/unlock request history (=0) stored in the storage unit 220, notifies the API of the occurrence of the event corresponding to the [Windows (registered trademark) key]+[L] key operation, and updates the request history to (=1).

Step S4: The API causes the OS to lock the system.

Next, the processing for switching the system from the locked state to the unlocked state will be described with reference to FIG. 2B.

Step S5: The button 210 is depressed.

Step S6: The input operation unit 21 notifies the button interface 22 of the depression of the button 210.

Step S7: The button interface 22 that received the notification from the input operation unit 21 detects the depression of the button 210, refers to the system lock/unlock request history (=1), notifies the API of the occurrence of the event corresponding to the [CTRL]+[ALT]+[DEL] key operation, and updates the request history to (−0).

Step S8: The API causes the OS to unlock the system.

In step S3, the mode switching processing unit 20 may update the request history to (=1) after checking with the API that the system lock by the API has successfully been accomplished in step S4. In this case, if the button 210 is depressed once again (the same situation as that in step S5) during the process of the system lock or because of failure of the system lock by the API in step S4, the process can be prevented from proceeding to step S7 via step S6 and erroneously notifying the API of the occurrence of the event corresponding to the [CTRL]+[ALT]+[DEL] key operation because the stored request history indicates the locked state (=1).

Likewise, in step S7, the mode switching processing unit 20 may update the request history to (=0) after checking with the API that the system unlock by the API has successfully been accomplished in step S8. In this case, if the button 210 is depressed once again (the same situation as that in step S1) during the process of the system unlock or because of failure of the system unlock by the API in step S7, the process can be prevented from proceeding to step S3 via step S2 and erroneously notifying the API of the occurrence of the event corresponding to the [Windows (registered trademark) key]+[L] key operation because the stored request history indicates the unlocked state (=0).

### EMBODIMENT 2

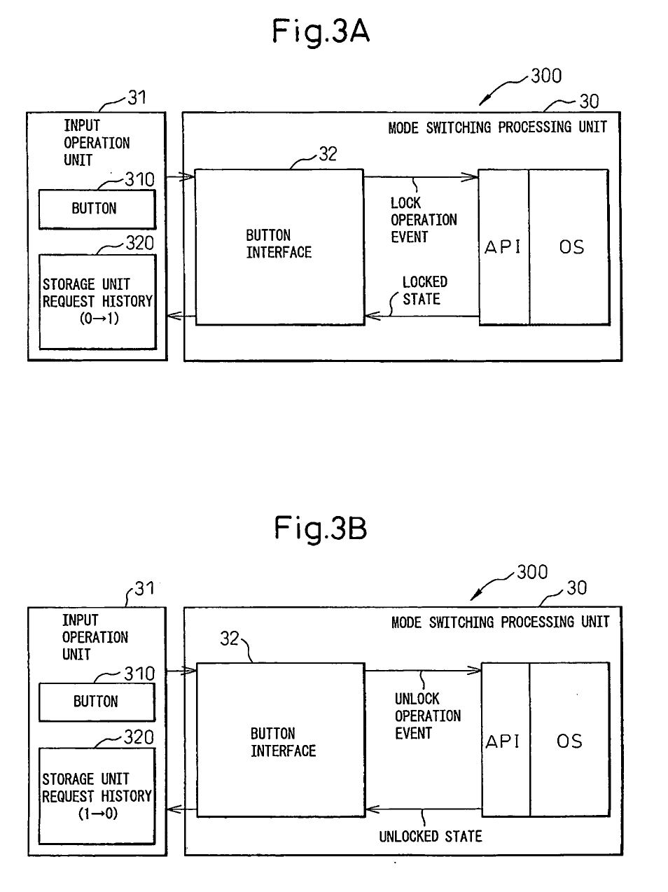

FIGS. 3A and 3B show a second embodiment of the processing for switching the system between the locked and unlocked states in response to the depression of the input operation unit: FIG. 3A is a diagram showing the processing for switching the system from the unlocked state to the locked state, and FIG. 3B is a diagram showing the processing for switching the system from the locked state to the unlocked state. As shown in FIGS. 3A and 3B, the mode switching processing unit 30 in the information processing apparatus 300 of this embodiment includes a storage unit 320 for storing the system's locked/unlocked state activated by the depression of the button 310 of the input operation unit 31 and effected by the mode switching processing unit 30.

First, the processing for switching the system from the unlocked state to the locked state will be described with reference to FIG. 3A.

Step S1: The button 310 is depressed.

Step S2: The input operation unit 31 notifies the button interface 32 of the depression of the button 310 with the system lock/unlock request history (=0) stored in the storage unit 320, and updates the request history to (=1).

Step S3: The button interface 32 detects the depression of the button 310, and notifies the API of the occurrence of the event corresponding to the [Windows (registered trademark) key]+[L] key operation.

Step S4: The API causes the OS to lock the system.

Next, the processing for switching the system from the locked state to the unlocked state will be described with reference to FIG. 3B.

Step S5: The button 310 is depressed.

Step S6: The input operation unit 31 notifies the button interface 32 of the depression of the button 310 with the request history (=1), and updates the request history to (=0).

Step S7: The button interface 32 detects the depression of the button 310, and notifies the API of the occurrence of the event corresponding to the [CTRL]+[ALT]+[DEL] key operation.

Step S8: The API causes the OS to unlock the system.

In step S2, the input operation unit 31 may update the request history to (=1) after checking with the API via the button interface 32 that the system lock by the API has successfully been accomplished in step S4. In this case, if the button 310 is depressed once again (the same situation as that in step S5) during the process of the system lock or because of failure of the system lock by the API in step S4, the process can be prevented from proceeding to step S6 and erroneously notifying the button interface 32 of the depression of the button 310 and thus causing the button interface 32 to notify the API of the occurrence of the event corresponding to the [CTRL]+[ALT]+[DEL] key operation because the stored request history indicates the locked state (=1).

Likewise, in step S6, the input operation unit 31 may update the request history to (=0) after checking with the API via the button interface 32 that the system unlock by the API has successfully been accomplished in step S8. In this case, if the button 310 is depressed once again (the same situation as that in step S1) during the process of the system unlock or because of failure of the system unlock by the API in step S8, the process can be prevented from proceeding to step S2 and erroneously notifying the button interface 32 of the depression of the button 310 and thus causing the button interface 32 to notify the API of the occurrence of the event corresponding to the [Windows (registered trademark) key]+[L] key operation because the stored request history indicates the locked state (=0).

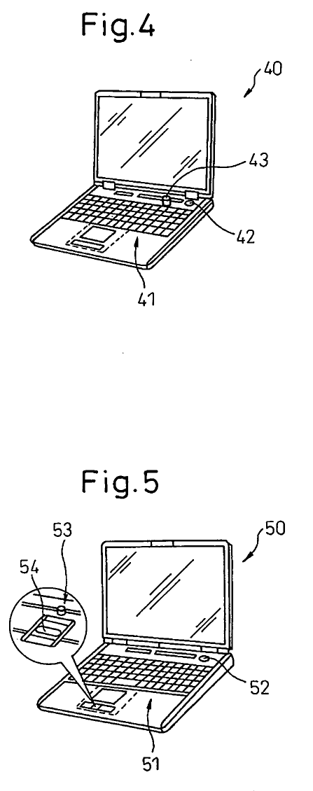

FIG. 4 is diagram showing a first arrangement example of a button and a fingerprint sensor on the information processing apparatus. In FIG. 4, an external view of a notebook PC 40 having an array of built-in application buttons is presented to show one specific example of the information processing apparatus.

The application buttons (not shown) are arranged on the keyboard 41 of the notebook PC 40 in an area that the user does not usually use. In the illustrated example, a button positioned next to a power button 42 is used as the button 43 of the present invention from among the application buttons. By arranging the button 43 of the present invention near the power button 42 and in an easy-to-remember position in the application button array, there is offered the advantage of enhancing the ease of the system lock/unlock operation of the present invention.

FIG. 5 is diagram showing a second arrangement example of a button and a fingerprint sensor on the information processing apparatus. The notebook PC 50 shown in FIG. 5 has a built-in fingerprint sensor 54. The button 53 of the present invention is located near the fingerprint sensor 54 of the notebook PC, or more specifically, upward of the scanning portion of the fingerprint sensor 54 in the illustrated example.

After the button 53 is depressed with a finger, the same finger is scanned over the scanning portion of the fingerprint sensor 54 to perform user authentication; since the system lock/unlock operation and the user authentication operation can be performed successively in the shortest possible time, the example shown here has the advantage that the ease of operation improves.

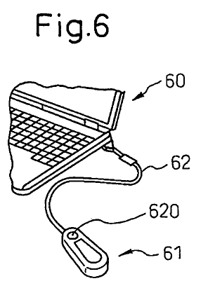

FIG. 6 is a diagram showing an example in which the button is incorporated into a fingerprint sensor externally connected to the information processing apparatus. As shown in FIG. 6, an external fingerprint recognition device 61 is connected to the notebook PC 60 via a USB cable 62. The button 620 of the present invention is located upward of the scanning portion of the external fingerprint recognition device 61.

As in the button arrangement example shown in FIG. 5, after the button 620 is depressed with a finger, the same finger is scanned over the scanning portion of the external fingerprint recognition device 61 to perform user authentication; since the system lock/unlock operation and the user authentication operation can be performed successively in the shortest possible time, this example also has the advantage that the ease of operation improves.

What is claimed is:

1. An information processing apparatus comprising:
one input operation unit which is operated in a specific way; and
a locked/unlocked mode switching processing unit which, when the input operation unit is operated in the specific way, carries out processing to emulate a prescribed operation corresponding to a lock request operation if the information processing apparatus is in an unlocked mode, but carries out processing to emulate a prescribed operation corresponding to an unlock request operation if the information processing apparatus is in a locked mode.

2. An information processing apparatus comprising:
one input operation unit which is operated in a specific way; and
a locked/unlocked mode switching processing unit which, when the input operation unit is operated in the specific way, carries out processing to emulate a [Windows (registered trademark) key]+[L] key operation corresponding to a lock request operation if the information processing apparatus is in an unlocked mode, but carries out processing to emulate a [CTRL]+[ALT]+[DEL] key operation corresponding to an unlock request operation if the information processing apparatus is in a locked mode.

3. An information processing apparatus as claimed in claim 1, further comprising a storage unit which, when the input operation unit is operated in the specific way while the information processing apparatus is in the unlocked mode, stores information indicating the information processing apparatus switched to the locked mode, and when the input operation unit is operated in the specific way while the information processing apparatus is in the locked mode, stores information indicating the information processing apparatus switched to the unlocked mode.

4. An information processing apparatus as claimed in claim 3, wherein the storage unit is provided within the mode switching processing unit, and wherein
when the input operation unit is operated in the specific way, the input operation unit communicates with the mode switching processing unit and checks the information stored in the storage unit to determine whether the information processing apparatus is in the locked mode or the unlocked mode, and
when it is determined that the information processing apparatus is in the unlocked mode, the input operation unit sends a lock request to the mode switching processing unit which, in response, carries out the processing to emulate the prescribed operation corresponding to the lock request operation, but
when it is determined that the information processing apparatus is in the locked mode, the input operation unit sends an unlock request to the mode switching processing unit which, in response, carries out the processing to emulate the prescribed operation corresponding to the unlock request operation.

5. An information processing apparatus as claimed in claim 3, wherein the storage unit is provided within the input operation unit, and wherein
when the input operation unit is operated in the specific way, the input operation unit checks the information stored in the storage unit to determine whether the information processing apparatus is in the locked mode or the unlocked mode, and
when it is determined that the information processing apparatus is in the unlocked mode, the input operation unit sends a lock request to the mode switching processing unit which, in response, carries out the processing to emulate the prescribed operation corresponding to the lock request operation, but
when it is determined that the information processing apparatus is in the locked mode, the input operation unit sends an unlock request to the mode switching processing unit which, in response, carries out the processing to emulate the prescribed operation corresponding to the unlock request operation.

6. An information processing apparatus as claimed in any one of claims 1 to 5, further comprising a biometric information reading unit, wherein
the input operation unit is disposed near the biometric information reading unit so that when the input operation unit is operated in the specific while the information processing apparatus is in the locked mode, an authentication operation using the biometric information reading unit can be performed immediately after the processing to emulate the prescribed operation corresponding to the unlock request operation has been carried out.

7. An information processing method for use in an information processing apparatus, comprising the steps of:
detecting a specific operation performed on one input operation unit; and
switching the information processing apparatus between locked and unlocked modes in such a manner that when the specific operation is detected, if the information processing apparatus is in the unlocked mode, processing is carried out to emulate a prescribed operation corresponding to a lock request operation; however if the information processing apparatus is in the locked mode, processing is carried out to emulate a prescribed operation corresponding to an unlock request operation.

8. An information processing method for use in an information processing apparatus, comprising the steps of:
detecting a specific operation performed on one input operation unit; and
switching the information processing apparatus between locked and unlocked modes in such a manner that when the specific operation is detected, if the information processing apparatus is in the unlocked mode, processing is carried out to emulate a [Windows (registered trademark) key]+[L] key operation corresponding to a lock request operation but, if the information processing apparatus is in the locked mode, processing is carried out to emulate a [CTRL]+[ALT]+[DEL] key operation corresponding to an unlock request operation.

9. An information processing method as claimed in claim 7, wherein the information processing apparatus includes a storage unit which, when the specific operation is performed on the input operation unit while the information processing apparatus is in the unlocked mode, stores information indicating the information processing apparatus switched to the locked mode, and when the specific operation is performed on the input operation unit while the information processing apparatus is in the locked mode, stores information indicating the information processing apparatus switched to the unlocked mode, and wherein
the mode switching processing step carries out the mode switching by referring to the information stored in the storage unit.

10. A program for use in an information processing apparatus and for causing the information processing apparatus to perform the steps of:
detecting a specific operation performed on one input operation unit; and
switching the information processing apparatus between locked and unlocked modes in such a manner that when the specific operation is detected, if the information processing apparatus is in the unlocked mode, processing is carried out to emulate a prescribed operation corresponding to a lock request operation but, if the information processing apparatus is in the locked mode, processing is carried out to emulate a prescribed operation corresponding to an unlock request operation.

11. A program for use in an information processing apparatus and for causing the information processing apparatus to perform the steps of:
detecting a specific operation performed on one input operation unit; and
switching the information processing apparatus between locked and unlocked modes in such a manner that when the specific operation is detected, if the information processing apparatus is in the unlocked mode, processing is carried out to emulate a [Windows (registered trademark) key]+[L] key operation corresponding to a lock request operation; however if the information processing apparatus is in the locked mode, processing is carried out to emulate a [CTRL]+[ALT]+[DEL] key operation corresponding to an unlock request operation.

12. A program as claimed in claim 10, wherein the information processing apparatus includes a storage unit which, when the specific operation is performed on the input operation unit while the information processing apparatus is in the unlocked mode, stores information indicating the information processing apparatus switched to the locked mode, and when the specific operation is performed on the input operation unit while the information processing apparatus is in the locked mode, stores information indicating the information processing apparatus switched to the unlocked mode, and wherein
the mode switching processing step carries out the mode switching by referring to the information stored in the storage unit.
